(19) United States
(12) Patent Application Publication
(10) Pub. No.: US 2021/0382803 A1
(43) Pub. Date: Dec. 9, 2021

(54) METHOD FOR REGULATING CHIP TEMPERATURE

(71) Applicant: AMLOGIC (SHANGHA) CO., LTD., Shanghai (CN)

(72) Inventors: Tao ZENG, Shanghai (CN); Yong WANG, Shanghai (CN)

(21) Appl. No.: 16/645,421

(22) PCT Filed: Oct. 31, 2018
(86) PCT No.: PCT/CN2018/113139

§ 371 Date: Mar. 6, 2020

(30) Foreign Application Priority Data
Oct. 11, 2017 (CN) 201710943277.1

(51) Int. Cl. G06F 11/30; G06F 11/07; G06F 1/20

(52) U.S. Cl. CPC G06F 11/3058; G06F 1/206; G06F 11/076; G06F 11/3024

(57) ABSTRACT

A method for regulating a chip temperature, belong to the technical field of integrated chips, and applied to multi-core processor chips. The method comprises: pre-setting a threshold set consisting of multiple thresholds gradated by magnitude; and further comprises: step S1, detecting, in real time, a real-time temperature produced by a processor chip; step S2, judging whether the real-time temperature has exceeded one or more thresholds in the threshold set; and step S3, using a pre-set strategy to shut down a pre-set rule number of cores corresponding to the number of thresholds exceeded by the real-time temperature. The method for regulating a chip temperature can deal with the scenario where a chip temperature is higher than a threshold due to continuous load increase, and has high reliability.

### BACKGROUND OF THE INVENTION

### 1. Field of the Invention

The invention relates to the field of integrated chips, and more particularly, to a method for regulating a chip temperature.

### 2. Description of the Related Art

The embedded processor is the core of an embedded system, and it is a hardware unit that controls and assists in the operation of the system. Since the microprocessor came out, the embedded system has developed rapidly. The embedded processor is undoubtedly the core of the embedded system, and the embedded processor is directly related to the performance of the whole embedded system. Generally, the embedded processor is often considered as the general term for computing and controlling core components in the embedded system.

As the performance of the embedded processor is improved and an area of a printed circuit board is reduced, temperature control has become an essential function of the embedded system. Higher temperature will not only affect the user experience of handheld embedded devices, but also have a strong impact on the stability of the system. The traditional temperature control method, for instance, a control method using an intelligent temperature control algorithm is confronted with a scenario where a load is always high, and the temperature has exceeded the threshold for a period of time, then the control may fail, and it may finally lead to a result that the temperature continues to rise, which in turn may cause the platform to restart due to its excessively heat temperature, and the chip may be burned. Of note, the reason for such a problem is that the leakage current of the chip increases with the increase of the temperature. Specifically, when the temperature is relatively high, the leakage current may even become the main source of heating problem. The following cycle may occur: the hotter the chip (is), the larger the leakage current (is), the higher the power consumption (is), and the higher the temperature (is). In addition, there is only one method for controlling the chip temperature.

### SUMMARY OF THE INVENTION

Aiming at the foregoing problems in the prior art, the present invention provides a method for regulating a chip temperature, applied to multi-core processor chips, wherein the method comprises: pre-setting a threshold set consisting of multiple thresholds gradated by magnitude; and further comprises:

step S1, detecting, in real time, a real-time temperature produced by a processor chip;

step S2, judging whether the real-time temperature has exceeded one or more thresholds in the threshold set; and

step S3, using a pre-set strategy to shut down a pre-set rule number of cores corresponding to the number of thresholds exceeded by the real-time temperature.

In the method for regulating a chip temperature, wherein a difference value between adjacent thresholds is the same.

In the method for regulating a chip temperature, wherein the pre-set rule number is equal to the number of thresholds exceeded by the real-time temperature.

In the method for regulating a chip temperature, wherein the pre-set strategy is as follows:

each threshold in the threshold set corresponds to a fixed core, respectively.

In the method for regulating a chip temperature, wherein the pre-set strategy is as follows:

each threshold in the threshold set corresponds to a random core, respectively.

In the method for regulating a chip temperature, wherein pre-setting an initial temperature control value that is lower than any threshold in the threshold set;

a step of primary cooling temperature is further included between step S1 and step S2, the step comprises: reducing a working frequency of the processor chip when the real-time temperature has exceeded the initial temperature control value.

In the method for regulating a chip temperature, wherein the processor chip is a central processing unit chip or a graphics processing unit chip.

By adopting the above-mentioned technical solution, the present invention has the following beneficial effects: the method for regulating a chip temperature according to the present invention can deal with the scenario where a chip temperature is higher than a threshold due to continuous load increase, and has high reliability.

### BRIEF DESCRIPTION OF THE DRAWINGS

The accompanying drawings, together with the specification, illustrate exemplary embodiments of the present disclosure, and, together with the description, serve to explain the principles of the present invention.

FIG. 1 is a flow chart showing steps of a method for regulating a chip temperature according to an embodiment of the present invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, certain exemplary embodiments according to the present disclosure will be described with reference to the accompanying drawings.

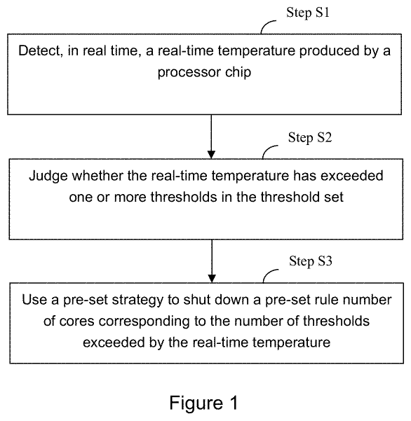

In a preferred embodiment, as show in FIG. 1, there is provided a method for regulating a chip temperature, applied to multi-core processor chips, wherein the method comprises: pre-setting a threshold set consisting of multiple thresholds gradated by magnitude; and further comprises:

step S1, detecting, in real time, a real-time temperature produced by a processor chip;

step S2, judging whether the real-time temperature has exceeded one or more thresholds in the threshold set; and

step S3, using a pre-set strategy to shut down a pre-set rule number of cores corresponding to the number of thresholds exceeded by the real-time temperature.

The above-mentioned technical solution and a traditional temperature control algorithm can be used simultaneously since they are not incompatible with each other, so as to ensure control of the chip temperature when the traditional temperature control algorithm fails to control the chip temperature as expected; for example, in Step 3 assuming there are 4 thresholds in the threshold set from low to high, and if the chip temperature exceeds one of the four thresholds (that is, the minimum threshold), a pre-set rule number of cores can be shut down, for example, one or two cores; at this time, the temperature of the processor chip may drop, but it may continue to rise. When the chip temperature continues to rise, for example, the chip temperature exceeds two of the four thresholds (that is, two smaller thresholds), one or two cores, for example, may be further shut down, since certain cores are in a shut-down state in a previous process, and the operation repeats until the pre-set number of cores are retained, or all of the cores are shut down. However, it is only a preferred example, and other examples are also deemed to be included in the present invention.

In a preferred embodiment, wherein a difference value between adjacent thresholds may be the same, so as to be adapted to cores having the same heating power. However, it is only a preferred example, other difference value can also be set.

In a preferred embodiment, wherein the pre-set rule number is equal to the number of thresholds exceeded by the real-time temperature, that is, each time the chip temperature exceeds a threshold, one core is shut down accordingly.

In a preferred embodiment, wherein the pre-set strategy is as follows:

each threshold in the threshold set corresponds to a fixed core, respectively, for example, each core has a fixed number, and different thresholds correspond to cores with different numbers.

In a preferred embodiment, wherein the pre-set strategy is as follows:

each threshold in the threshold set corresponds to a random core, respectively.

In a preferred embodiment, wherein pre-setting an initial temperature control value that is lower than any thresholds in the threshold set;

a step of primary cooling temperature is further included between step S1 and step S2, the step comprises: reducing a working frequency of the processor chip when the real-time temperature exceeds the initial temperature control value.

In the above-mentioned technical solution, when a measure of reducing the working frequency fails, and the temperature continues to rise, a mechanism for closing the core can be triggered, so as to ensure the chip temperature is limited.

In a preferred embodiment, wherein the processor chip is a central processing unit chip or a graphics processing unit chip.

In conclusion, the present invention provides a method for regulating a chip temperature, applied to multi-core processor chips. The method comprises: pre-setting a threshold set consisting of multiple thresholds gradated by magnitude; and further comprises: step S1, detecting, in real time, a real-time temperature produced by a processor chip; step S2, judging whether the real-time temperature has exceeded one or more thresholds in the threshold set; and step S3, using a pre-set strategy to shut down a pre-set rule number of cores corresponding to the number of thresholds exceeded by the real-time temperature. The method for regulating a chip temperature can deal with the scenario where a chip temperature is higher than a threshold due to continuous load increase, and has high reliability.

With reference to detailed description and the accompanying drawings, typical embodiments of a particular structure of the detailed description are given; while other transformation of the particular structure may be done without departing from the spirit of the present invention. Although the existing preferred embodiments are put forward in the present invention, the present invention is not limited thereto.

Variations and modifications of the present invention will be more apparent to those skilled in the art with reference to the above-mentioned detailed description. Therefore, it is intended to cover all variations and modifications within the true purpose and scope of the present invention as defined by the appended claims. Any and all the equivalents are construed to fall within the purpose and scope of the present invention.

What is claimed is:

1. A method for regulating a chip temperature, applied to multi-core processor chips, the method comprising: pre-setting a threshold set consisting of multiple thresholds gradated by magnitude; and further comprising:
step S1, detecting, in real time, a real-time temperature produced by a processor chip;
step S2, judging whether the real-time temperature has exceeded one or more thresholds in the threshold set; and
step S3, using a pre-set strategy to shut down a pre-set rule number of cores corresponding to the number of thresholds exceeded by the real-time temperature.

2. The method for regulating a chip temperature of claim 1, wherein a difference value between adjacent thresholds is the same.

3. The method for regulating a chip temperature of claim 1, wherein the pre-set rule number is equal to the number of thresholds exceeded by the real-time temperature.

4. The method for regulating a chip temperature of claim 3, wherein the pre-set strategy is as follows:
each threshold in the threshold set corresponds to a fixed core, respectively.

5. The method for regulating a chip temperature of claim 3, wherein the pre-set strategy is as follows:
each threshold in the threshold set corresponds to a random core, respectively.

6. The method for regulating a chip temperature of claim 1, wherein pre-setting an initial temperature control value that is lower than any threshold in the threshold set;
a step of primary cooling temperature is further included between step S1 and step S2, the step comprises: reducing a working frequency of the processor chip when the real-time temperature exceeds the initial temperature control value.

7. The method for regulating a chip temperature of claim 1, wherein the processor chip is a central processing unit chip or a graphics processing unit chip.
